(19) United States
(12) Patent Application Publication
(10) Pub. No.: US 2015/0186103 A1
(43) Pub. Date: Jul. 2, 2015

(54) Digital Radio Recorder (DRR)

(71) Applicant: Derek Jon Thurmes, Saint Paul, MN (US)

(72) Inventor: Derek Jon Thurmes, Saint Paul, MN (US)

(21) Appl. No.: 14/144,480

(22) Filed: Dec. 30, 2013

(51) Int. Cl. G06F 3/16

(52) U.S. Cl. CPC G06F 3/165

(57) ABSTRACT

A Digital Radio Recorder (DRR) comprising of the digital recording of digital and analog AM and FM over-the-air radio signals, sound waves and any other associated data and information transmitted with the signal. Upon user selection, the DRR will have the capability to continuously record and save the radio signals mentioned above for a user defined period or until the storage capacity is reached. The DRR will also provide a rolling buffer, for example the last 1 hour, 2 hours or 3 hours, of ongoing over-the-air radio signals which will allow the user to instantly pause, rewind and fast forward the sound file within the ongoing rolling buffer. The user will have the ability to transfer the recorded files to other digital devices such as Smart Phones, MP3 players, Computers, Laptops, etc. The DRR can be used in car radios, home stereos or other portable audio devices.

### CROSS-REFERENCE TO RELATED APPLICATIONS: Not Applicable

### STATEMENT REGARDING FEDERALLY SPONSORED RESEARCH OR DEVELOPMENT: Not Applicable

### REFERENCE TO SEQUENCE LISTING, A TABLE, OR A COMPUTER PROGRAM LISTING COMPACT DISC APPENDIX: Not Applicable

### BACKGROUND OF THE INVENTION

The invention of the Digital Radio Recorder (DRR) is designed to provide an easy way for people to record, pause, rewind and replay radio programming using digital recording to a disk drive, Solid State Drive, USB flash drive, SD memory card or other local or networked mass storage device without the need for a cassette tape or Compact Disc.

### BRIEF SUMMARY OF THE INVENTION

The Digital Radio Recorder (DRR) will solve the issue of people missing radio programming and providing people with an easy way to replay radio programs. In certain situations, people could benefit from the ability to record and pause radio programs or songs. For example, if somebody needs to take a phone call while riding in a car, they could pause and record (buffer) the radio program. Once they are finished with the call, they can un-pause the radio and play the buffered radio program without missing anything. The DRR will also provide people with the ability to rewind a portion of a radio program if they missed something that was said, they mis-heard something or they were not paying close attention to what was on the radio. A rolling buffer of radio programming would allow somebody to rewind and replay the radio and then allow them to go back to listening to live programming if desired.

### BRIEF DESCRIPTION OF THE SEVERAL VIEWS OF THE DRAWING

Not Applicable

### DETAILED DESCRIPTION OF THE INVENTION

A Digital Radio Recorder (DRR) comprising of the digital recording of digital and analog AM and FM over-the-air radio signals, sound waves and any other associated data and information transmitted with the signal, to a disk drive, USB flash drive, SD memory card or other local or networked mass storage device without the need for a cassette tape or Compact Disc. Upon user selection, the DRR will have the capability to continuously record and save the radio signals mentioned above for a user defined period or until the storage capacity is reached. The DRR will also provide a rolling buffer, for example the last 1 hour, 2 hours or 3 hours (depending on the storage capacity), of ongoing over-the-air radio signals which will allow the user to instantly pause, rewind and fast forward the sound file within the ongoing rolling buffer.

The DRR will allow the user to save multiple individual recorded sound files for playback on the DRR upon user selection. The sound files will be stored until the storage capacity is reached or until the user deletes a stored recorded sound file. The DRR will provide an option to allow a user to provide a name or identification with alpha-numeric characters to each stored sound file that was recorded. In addition, associated data transmitted over-the-air with the music file such as the artist name and song title shall also be automatically stored with the sound file. The DRR will include a display to indicate a previously stored sound file name or identification, the time length of the recorded sound file and the time length of the rolling buffer.

The user will have the ability to transfer the recorded files to other digital devices such as Smart Phones, MP3 players, Computers, Laptops, etc. The user will have the ability to transfer the files via a USB connection, Bluetooth, wireless network, etc. The DRR can be used in car radios, home stereos, MP3 players or other portable audio devices.

The embodiments of the invention in which an exclusive property or privilege is claimed are defined as follows:

1. A Digital Radio Recorder (DRR) comprising the digital recording of digital and analog AM and FM over-the-air radio signals, sound waves and any other associated data and information transmitted with the signal, to a disk drive, Solid State Drive, USB flash drive, SD memory card or other local or networked mass storage device without the need for a cassette tape or Compact Disc.

2. The DRR of claim 1 comprises the ability to save multiple individual recorded sound files for playback on the DRR upon user selection including the ability to pause, rewind and fast forward the sound file.

3. The DRR of claim 1 comprises a rolling digital buffer, for example the last 1 hour, 2 hours or 3 hours (depending on the storage capacity), of ongoing over-the-air radio signals which will allow the user to instantly pause, rewind and fast forward the sound file within the ongoing rolling buffer and instantly resume live programming.

4. The DRR of claim 1 comprises the ability to allow a user to provide a name or identification with alpha-numeric characters to each stored sound file that was recorded. In addition, associated data transmitted over-the-air with the music file such as the artist name and song title shall also be automatically stored with the sound file.

5. The DRR of claim 1 comprises the ability to transfer the recorded files to other digital devices such as Smart Phones, MP3 players, Computers, Laptops, etc. by means of a USB connection, Bluetooth, wireless network or other file transfer methods.

6. The DRR of claim 1 comprises the ability to digitally record the digital and analog AM and FM over-the-air radio signals in a car radio, home stereo, MP3 player or any other portable audio device or radio receiver.

7. The DRR of claim 1 comprises the ability to schedule recordings of programs in the future such as scheduling a recording of an upcoming radio program.
